(19) United States
(12) Patent Application Publication
(10) Pub. No.: US 2021/0187669 A1
(43) Pub. Date: Jun. 24, 2021

(54) LIGHT SHIELD AND LASER PROCESSING SYSTEM

(71) Applicant: FANUC CORPORATION, Yamanashi (JP)

(72) Inventor: Yoshitake FURUYA, Yamanashi (JP)

(73) Assignee: FANUC CORPORATION, Yamanashi (JP)

(21) Appl. No.: 17/090,035

(22) Filed: Nov. 5, 2020

(30) Foreign Application Priority Data
Dec. 24, 2019 (JP) 2019-232861

(51) Int. Cl. B23K 26/70

(52) U.S. Cl. CPC B23K 26/706

(57) ABSTRACT

A light shield that houses a space where a workpiece is disposed during laser processing performed by a robot with the workpiece or a laser emitting device mounted on a tip of a wrist of the robot, the light shield includes a plurality of shield members capable of forming a closed space by being combined, at least one of the shield members is provided to be movable between a state where the shield member is away from another shield member of the shield members and a state where the shield member is combined with the other shield member, and an opening configured to allow a part of the robot to pass without a gap being defined at a position of a boundary between the two combined shield members.

### CROSS-REFERENCE TO RELATED APPLICATIONS

This application is based on and claims priority to Japanese Patent Application No. 2019-232861 filed on Dec. 24, 2019, the content of which is incorporated herein by reference in its entirety.

### FIELD

The present disclosure relates to a light shield and a laser processing system.

### BACKGROUND

A laser processing device is known in which a laser light emitting head or a workpiece is mounted to a robot and the workpiece is processed with laser light (e.g., see Japanese Unexamined Patent Application, Publication No. 2008-114458).

To shield laser light of this laser processing system not to be emitted outside, the laser processing system including the whole body of the robot is surrounded with a light shield.

### SUMMARY

An aspect of the present disclosure is a light shield that houses a space where a workpiece is disposed during laser processing performed by a robot with the workpiece or a laser emitting device mounted on a tip of a wrist of the robot, the light shield including a plurality of shield members capable of forming a closed space by being combined, wherein at least one of the shield members is provided to be movable between a state where the shield member is away from another shield member of the shield members and a state where the shield member is combined with the other shield member, and an opening configured to allow a part of the robot to pass without a gap is defined at a position of a boundary between the two shield members that are combined.

### BRIEF DESCRIPTION OF DRAWINGS

FIG. 1 is an overall configuration diagram showing a laser processing system according to an embodiment of the present disclosure.

FIG. 2 is a perspective view showing an opened state of a light shield according to the embodiment of the present disclosure provided in the laser processing system of FIG. 1.

FIG. 3 is a perspective view showing a closed state of the light shield of FIG. 2.

FIG. 4 is an overall configuration diagram showing a state where the light shield of the laser processing system of FIG. 1 is closed to perform laser processing.

FIG. 5 is a perspective view showing an opened state of a modification of the light shield of FIG. 2.

FIG. 6 is a perspective view showing a closed state of the light shield of FIG. 5.

FIG. 7 is a front view of the light shield of FIG. 5.

### DETAILED DESCRIPTION OF EMBODIMENTS

Hereinafter, description will be made as to a light shield 4 and a laser processing system 1 according to an embodiment of the present disclosure with reference to the drawings.

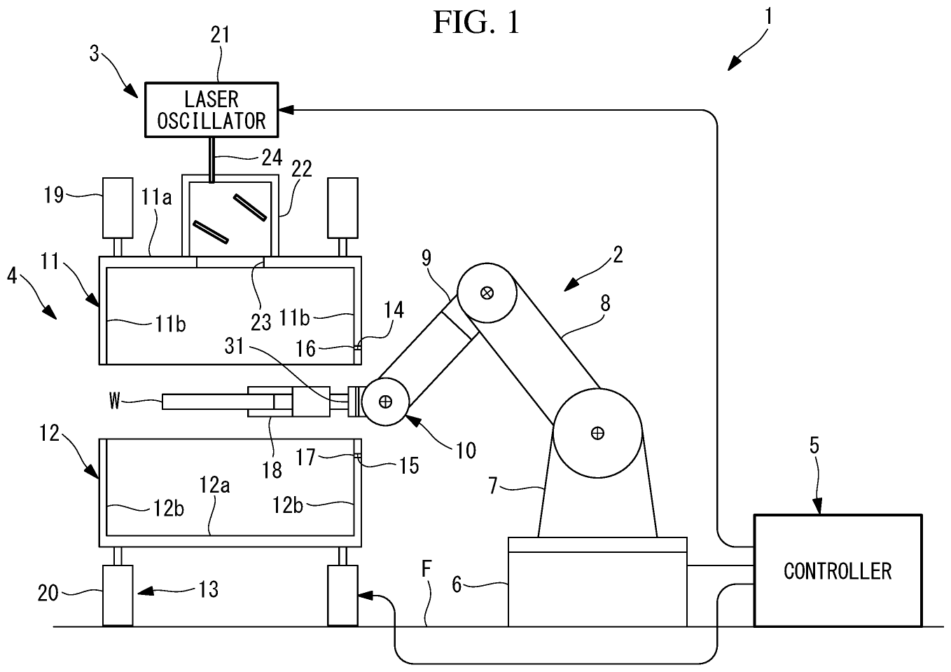

As shown in FIG. 1, the laser processing system 1 according to the present embodiment is provided with a robot 2 having a tip of a wrist unit (a wrist) 10 to which a workpiece W is mounted, a laser processing device 3 that processes the workpiece W with laser light, a light shield 4 according to the present embodiment, and a controller 5 that controls these components.

The robot 2 is, for example, a vertical 6-axis articulated robot. The robot 2 includes a base 6 fixed to a floor surface F, a swivel body 7 supported rotatably about a vertical first axis to the base 6, and a first arm 8 supported swingably about a horizontal second axis to the swivel body 7.

Furthermore, the robot 2 includes a second arm 9 supported rotatably about a horizontal third axis to the first arm 8, and a three-axis wrist unit 10 is attached to a tip of the second arm 9.

As shown in FIG. 1 to FIG. 3, the light shield 4 according to the present embodiment is provide with an upper box member (a shield member) 11 and a lower box member (a shield member) 12 that are combined to form a rectangular parallelepiped box body, and an opening/closing mechanism 13 that opens and closes these members. The upper box member 11 and the lower box member 12 are composed of a material that can shield the laser light.

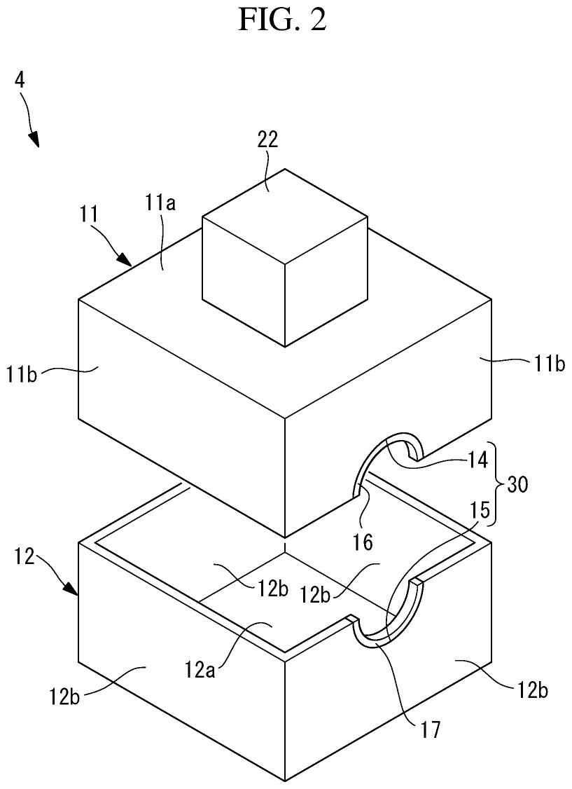

As shown in FIG. 2, the upper box member 11 is provided with a rectangular top plate 11a and four side walls (wall surfaces) 11b extending vertically downward from four sides of the top plate 11a, and is formed in a box shape that does not include a bottom plate.

As shown in FIG. 2, the lower box member 12 is provide with a bottom plate 12a having about the same shape as the top plate 11a and four side walls (wall surfaces) 12b extending vertically upward from four sides of the bottom plate 12a, and is formed in a box shape that does not include the top plate.

A lower edge (a boundary) of one of the side walls 11b of the upper box member 11 is provided with a semicircular cutout 14 at a center position of the lower edge in a width direction.

Furthermore, an upper edge (a boundary) of one of the side walls 12b of the lower box member 12 is provided with a semicircular cutout 15 at a center position of the upper edge in the width direction.

A radius of the cutout 14, 15 is, for example, slightly larger than a radius of a flange 31 of the tip of the wrist unit 10 of the robot 2. An elastic member 16, 17 such as a sponge rubber that is elastically deformable when pressed is disposed over a whole circumference of an inner edge of the cutout 14, 15. The elastic member 16, 17 is also composed of a material that can shield the laser light.

The upper box member 11 and the lower box member 12 are arranged at positions where the lower edge of the upper box member 11 and the upper edge of the lower box member 12 butt against each other, and the semicircular cutout 14 of the upper box member 11 and the semicircular cutout 15 of the lower box member 12 are arranged at positions where the cutouts butt against each other to form a round opening 30.

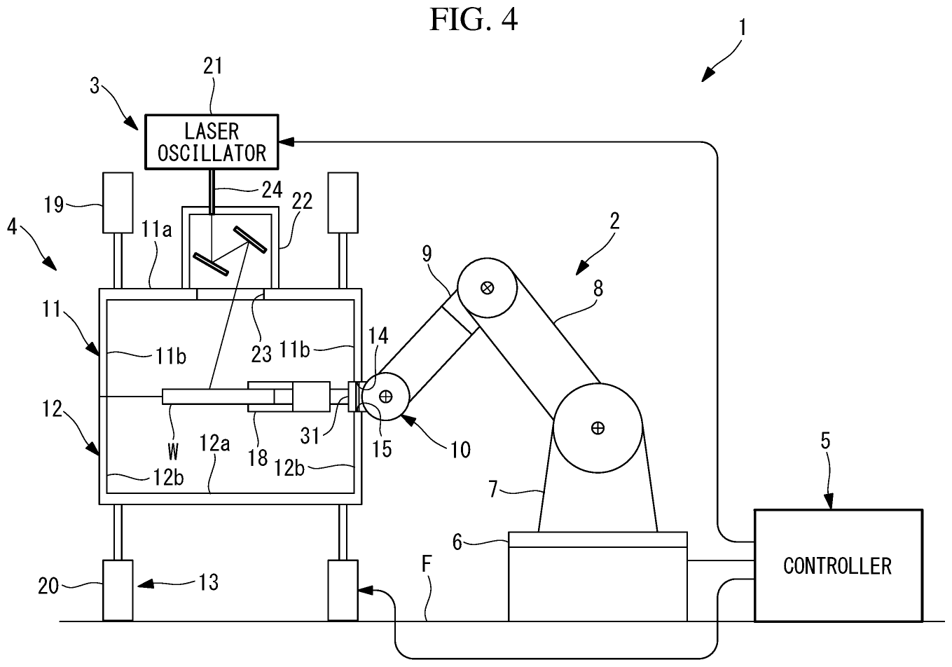

As shown in FIG. 4, the upper box member 11 and the lower box member 12, when combined, is of sufficient size that a hand 18 attached to the tip of the wrist unit 10 of the robot 2 and the workpiece W grasped with the hand 18 can be housed and rotated inside.

The opening/closing mechanism 13 includes an upper direct drive mechanism 19 that raises and lowers the upper box member 11, and a lower direct drive mechanism 20 that raises and lowers the lower box member 12. The upper direct drive mechanism 19 is, for example, an air cylinder, and raises and lowers the upper box member 11 attached to a tip of a rod in a vertical direction between a lower end position where it butts against the lower box member 12 and an upper end position where it is disposed vertically above the lower end position.

The lower direct drive mechanism 20 is also, for example, an air cylinder, and raises and lowers the lower box member 12 attached to a tip of a rod in a vertical direction between an upper end position where it butts against the upper box member 11 and a lower end position where it is disposed vertically below the upper end position.

The laser processing device 3 includes a laser oscillator 21 that generates the laser light, and a scanner 22 that scans the laser light emitted from the laser oscillator 21. The scanner 22 is fixed to an upper part of the top plate 11a of the upper box member 11. The top plate 11a is provided with a through portion 23 through which the laser light output from the scanner 22 passes into the upper box member 11. The laser oscillator 21 is connected to the scanner 22 by an optical fiber 24, and the laser light emitted from the laser oscillator 21 enters the scanner 22 via the optical fiber 24.

Hereinafter, description will be made as to operations of the light shield 4 and the laser processing system 1 according to the present embodiment having such a configuration.

To perform laser processing of the workpiece W by use of the laser processing system 1 according to the present embodiment, the controller 5 actuates the opening/closing mechanism 13 to move the upper box member 11 to the upper end position and the lower box member 12 to the lower end position, as shown in FIG. 2. As a result, a sufficient gap is made between a lower end of the upper box member 11 and an upper end of the lower box member 12.

Next, the controller 5 actuates the robot 2 to grasp the workpiece W with the hand 18. As shown in FIG. 1, the grasped workpiece W is disposed in the gap between the upper box member 11 and the lower box member 12.

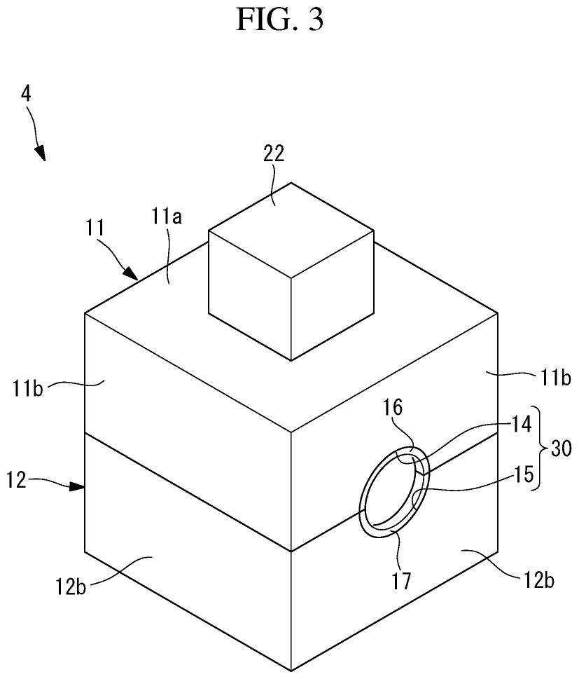

In this state, the controller 5 actuates the opening/closing mechanism 13 to move the upper box member 11 to the lower end position and the lower box member 12 to the upper end position, as shown in FIG. 3. This causes the lower edge of the upper box member 11 and the upper edge of the lower box member 12 to butt against each other, sealing the space therebetween, and the light shield 4 made of a rectangular parallelepiped box body is formed.

At this time, the semicircular cutout 14 formed in the lower edge of the upper box member 11 and the semicircular cutout 15 formed in the upper edge of the lower box member 12 are combined to form the round opening 30. As shown in FIG. 4, the flange 31 of the tip of the wrist unit 10 of the robot 2 passes through the formed opening 30. The elastic members 16, 17 are arranged in the cutouts 14, 15, and hence the elastic members 16, 17 are pressed onto an outer peripheral surface of the flange 31 and accordingly elastically deformed, to fill the gap between the cutouts 14, 15 and the outer peripheral surface of the flange 31.

In this state, the hand 18 attached to the tip of the wrist unit 10 of the robot 2 and the workpiece W grasped with the hand 18 are housed in the light shield 4. The flange 31 of the robot 2 is made to pass through the opening 30 formed in the light shield 4, so that only a tip shaft can be rotated without changing relative positions of the flange 31 and the opening 30. This allows the workpiece W to be rotated inside the light shield 4.

Then, the controller 5 controls the laser processing device 3, to irradiate a desired position on the workpiece W with the laser light emitted from the laser oscillator 21 by the scanner 22 as shown in FIG. 4, so that the laser processing can be performed to the workpiece W.

In this case, since the workpiece W is covered with the light shield 4, the laser light can be more reliably prevented from leaking to outside.

That is, according to the laser processing system 1 of the present embodiment, a region including the whole body of the robot 2 is not surrounded with the light shield 4, but only a region including the tip of the wrist unit 10 of the robot 2 and the workpiece W is surrounded with the light shield 4. This has an advantage that the whole laser processing system 1 does not need to be increased in size.

In the present embodiment, the upper box member 11 and the lower box member 12 are moved in an up-down direction by the opening/closing mechanism 13. Alternatively, the members may be moved in an arbitrary direction, for example, in a horizontal direction. Furthermore, the air cylinder is employed as the opening/closing mechanism 13. Alternatively, a direct drive mechanism provided with a motor and a ball screw or another actuator may be employed.

Furthermore, both the upper box member 11 and the lower box member 12 are moved. Alternatively, one of these members may be fixed, and only the other member may be moved.

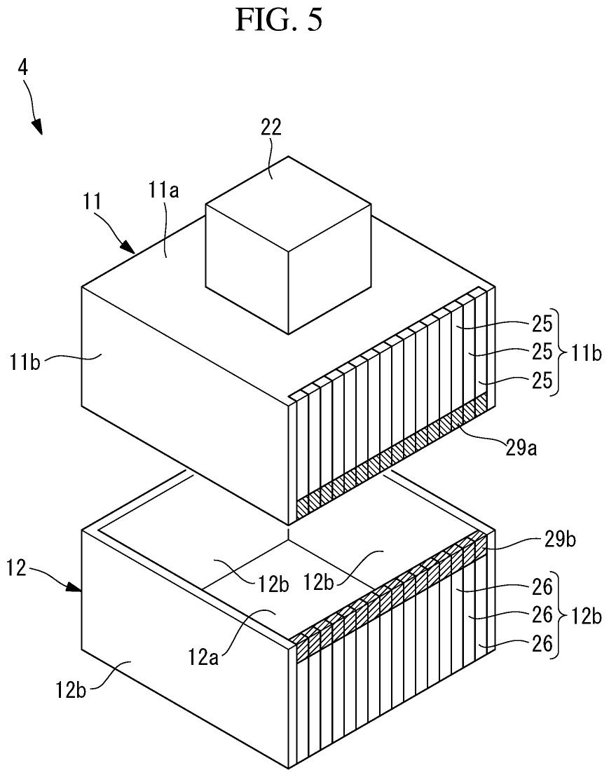

Additionally, in the present embodiment, the upper box member 11 and the lower box member 12 including the semicircular cutouts 14, 15 are employed. Alternatively, in place of the wall surfaces 11b, 12b of the upper box member 11 and the lower box member 12 in which the opening 30 is formed, as shown in FIG. 5 to FIG. 7, wall surfaces may be employed on which a plurality of band plate-shaped strip members (longitudinal members) 25, 26 extending in a moving direction of the upper box member 11 and the lower box member 12 are arranged adjacent to one another in a width direction without a space.

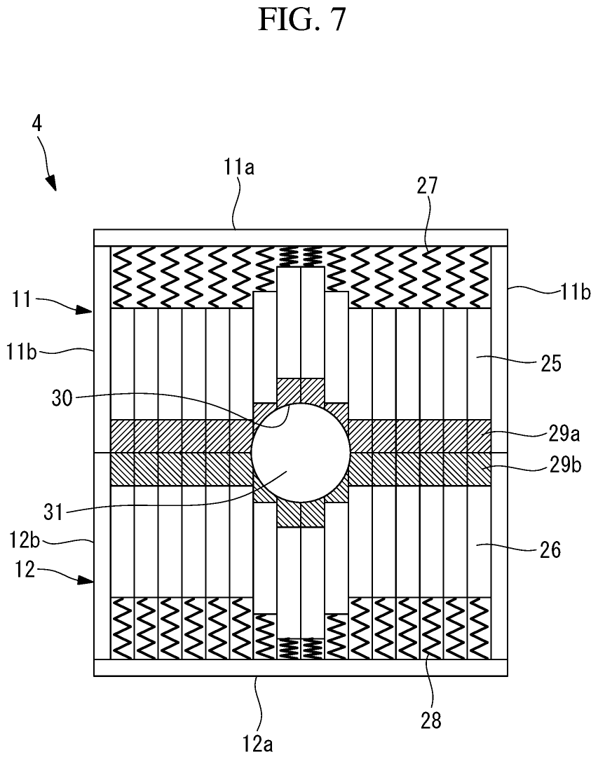

The respective strip members 25, 26 are each provided movable in the moving direction (a longitudinal direction) of the upper box member 11 and the lower box member 12. As shown in FIG. 7, the strip members are urged in directions toward tips that form boundaries, by springs (urging mechanisms) 27, 28.

Therefore, the lower edge of the upper box member 11 and the upper edge of the lower box member 12, with nothing in between, are pushed by the springs 27, 28. Consequently, as shown in FIG. 5, the strip members are linearly aligned, respectively.

Furthermore, in the tips of the respective strip members 25, 26, elastic members (elastic bodies) 29a, 29b composed of a sponge rubber or the like are arranged to be elastically deformable in accordance with an outer surface shape of the robot 2.

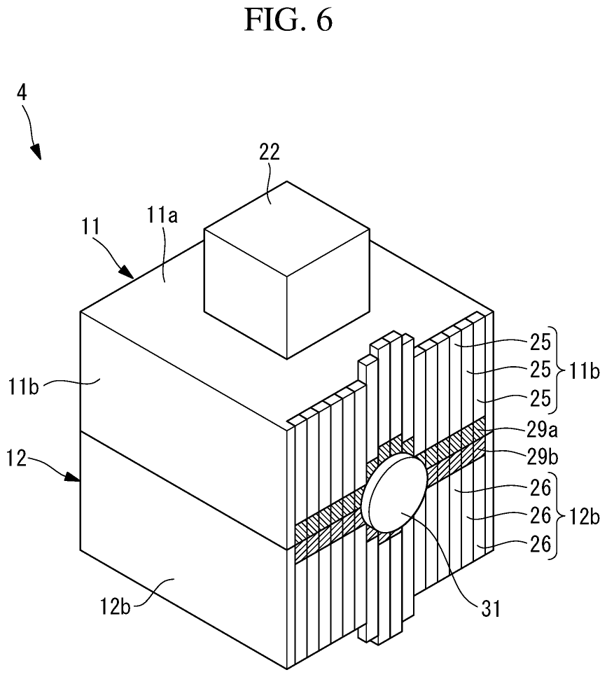

Then, when the lower edge of the upper box member 11 and the upper edge of the lower box member 12 are brought close to each other with the flange 31 of the robot 2 is placed between the edges, the strip members 25, 26 of the portions in contact with the flange 31 are pushed against urging forces of the springs 27, 28 and moved in the longitudinal direction, as shown in FIG. 6 and FIG. 7. Accordingly, as the upper box member 11 and the lower box member 12 come close to each other, an opening 30 surrounding the flange 31 is formed following a shape of the flange 31. Therefore, only the region including the tip of the wrist unit 10 of the robot 2 and the workpiece W can be subjected to laser processing while being surrounded with the light shield 4 in the same manner as described above.

According to this structure, the opening 30 is formed by pressing the edges of the strip members 25, 26 against the outer peripheral surface of the flange 31 of the robot 2, and hence a position where the flange 31 is interposed can be freely set in the width direction of the strip members 25, 26. In this case, it is preferable that the strip members 25, 26 have a comparatively small width dimension, because the opening 30 can be accurately formed in the outer peripheral surface of the flange 31 of the robot 2.

In place of the springs 27, 28 that urge the strip members 25, 26, a direct drive mechanism including a motor and a ball screw may be employed, and the controller 5 may control each motor based on positional information of the robot 2 to change a position of the opening 30. This allows the position of the opening 30 to be changed, while moving the robot 2, and a posture of the workpiece W can be more freely changed.

Furthermore, the wall surfaces 11b, 12b on which the strip members 25, 26 are arranged do not have to be provided only on one surface, and may be provided on two surfaces or more. Additionally, to form the opening 30 that accurately follows the shape of the outer peripheral surface of the flange 31 of the robot 2, pins having a small diameter and a round cross section may be arranged and formed in place of the strip members 25, 26.

Additionally, in the present embodiment, the flange 31 of the robot 2 is made to pass through the opening 30 formed in one wall surface of the upper box member 11 and the lower box member 12. Alternatively, an arbitrary position of the robot 2 may be opened. However, in order to pass the flange through the opening 30 having a defined shape or the opening 30 formed by moving the strip members 25, 26, it is preferable that the opening is a portion having a simply round, elliptic or another cross sectional shape. With the simple shape, the light shield 4 can be more reliably formed without any gaps by elastic deformation of the elastic member 16, 17, 29a, or 29b.

Furthermore, in the present embodiment, it has been illustrated that the workpiece W is grasped with the hand 18 attached to the tip of the wrist unit 10 of the robot 2. Alternatively, the present invention may be applied to a case where the workpiece W is disposed within the light shield 4, and a laser emitting device is supported on the robot 2.

1. A light shield that houses a space where a workpiece is disposed during laser processing performed by a robot with the workpiece or a laser emitting device mounted on a tip of a wrist of the robot, the light shield comprising:
a plurality of shield members capable of forming a closed space by being combined,
at least one of the shield members is provided to be movable between a state where the shield member is away from another shield member of the shield members and a state where the shield member is combined with the other shield member, and
an opening configured to allow a part of the robot to pass without a gap is defined at a position of a boundary between the two shield members that are combined.

2. The light shield according to claim 1, wherein the two shield members respectively comprise cutouts which form the opening when the two shield members are combined.

3. The light shield according to claim 1, wherein
wall surfaces of the two shield members in which the opening is provided are formed by arranging a plurality of longitudinal members, which extend in a moving direction of the shield members, so that the longitudinal members are arranged adjacent to one another without a gap in a direction orthogonal to the moving direction,
each of the longitudinal members is movable in a longitudinal direction, and
the light shield further comprises an urging mechanism that urges each longitudinal member in a direction toward a tip that forms the boundary.

4. The light shield according to claim 3, wherein the urging mechanism is a spring.

5. The light shield according to claim 3, wherein the tip of the longitudinal member comprises an elastic member that is deformable in accordance with an outer surface shape of the robot.

6. A laser processing system comprising the light shield according to claim 1.
